(19) United States
(12) Patent Application Publication
(10) Pub. No.: US 2010/0201496 A1
(43) Pub. Date: Aug. 12, 2010

(54) METHOD AND DEVICE FOR THE CONTACT-FREE TRANSMISSION OF DATA FROM AND/OR TO A PLURALITY OF DATA OR INFORMATION CARRIERS, PREFERABLY IN THE FORM OF RFID TAGS

(75) Inventors: Gerald Schillmeier, Munchen (DE); Thomas Lankes, Rosenheim (DE); Frank Mierke, Munchen (DE)

Correspondence Address: NIXON & VANDERHYE, PC, 901 NORTH GLEBE ROAD, 11TH FLOOR, ARLINGTON, VA, 22203, US

(73) Assignee: Kathrein-Werke KG, Rosenheim (DE)

(21) Appl. No.: 12/670,753

(22) PCT Filed: Jul. 24, 2008
(86) PCT No.: PCT/EP2008/006096

§ 371 Date: Jan. 26, 2010

(30) Foreign Application Priority Data
Jul. 26, 2007 (DE) 2007 035 006.8

(51) Int. Cl. H04Q 5/22

(52) U.S. Cl. 340/10.4

(57) ABSTRACT

A method and device for contact-free transmission of data from and/or to a plurality of data or information carriers provide that, after the exchange of information between a read and/or write device and a data or information carrier, said carrier is switched to a standby impedance mode in order to reduce undesired interaction with data or information carriers adjoining the antenna field. This mode differs from an initial impedance mode and communication impedance modes during the emission of an information signal from the data or information carrier.

The invention relates to a method and a device for the contact-free transmission of data from and/or to a large number of data or information carriers, in particular in the form of RFID tags, in accordance with the preamble of claim 1 and claim 16 respectively.

RFID methods for the contact-free identification of information stored on what are known as RFID tags, using magnetic, electric and/or electromagnetic energy and data transmission, have long been known. The RFID (radiofrequency identification) method is one way of reading information located on portable data carriers in a contact-free manner and/or writing information to the portable data carrier. Use is made of what are known as passive RFID tags, which always obtain their energy from the electric, magnetic and/or electromagnetic field of an antenna, or of what are known as active RFID tags, which are provided with their own (chargeable) energy supply. In general, RFID tags are what are known as transponders.

These RFID tags may be used for a wide variety of applications, in particular for sensing (detecting, identifying) objects and/or products of a wide variety of types, for example for identifying and sensing items of clothing, for example T-shirts etc.

As is known, RFID tags and the associated identification methods are constructed and implemented with a read and/or write device (known as a reader) provided. The reader is attached to an antenna, via which the corresponding interrogation signals may be transmitted and the corresponding information responses from tags may be received. In the RFID method, this transmission and reception often take place at the same frequency (although it is also possible to transmit and receive at different frequencies). The signal transmitted by the antenna of the read and/or write device may simultaneously act as the energy supply for the tags. The corresponding information is read from the tag and sent back to the transmission and/or reception device, which can capture and evaluate the corresponding signal via an associated antenna. There is thus a bidirectional transmission and reception path in the same frequency range or frequency band. Different frequency bands may be authorised for this technique for this purpose in different countries.

If there are a plurality of tags in the read region of an RFID read and/or write device, then collisions may occur during reading. For this reason, various anti-collision methods have already been proposed so that correct sensing and reading of different tags can be carried out.

It has also already been proposed for the respective tag which has just been read to be “silenced” or “deactivated” after being read. A silenced or deactivated tag remains deactivated or silenced until it is directly addressed again. However, even when it has been “silenced” or “deactivated”, the tag still remains active in high-frequency terms, as it still takes up power for example.

It is particularly problematic if a large number of tags are arranged alongside one another in a narrow space, for example because tags are being used to distinguish T-shirts or the like and the T-shirts in this case are positioned directly on top of one another. This results in the tags interfering with one another, with the result that some tags can only be accessed and read with difficulty.

The object of the present invention is therefore to provide an improved method and an improved device which allows more tags to be accessed and addressed in an intake region of one or more antennae of a read and/or write device and allows data to be read from or written to a tag, i.e. allows improved communication to be established between the reader (i.e. a read and/or write device) and the respective tag or, in general, transponder.

This object is achieved for the method by the features specified in claim 1 and for the device by the features specified in claim 16. Advantageous embodiments of the invention are provided in the subclaims.

The present invention provides a substantial improvement by surprising means. By contrast with conventional solutions, with the invention it is now possible to allow even tags which are spatially positioned extremely close to one another to be read and/or written more effectively and more reliably, and/or to increase the read and/or write region (intake region) of the reader with the associated antenna or antennae at the same transmission and/or receiving power.

According to the invention, this is achieved by carrying out an impedance circuit alteration on the tags (or, in general, transponder), and specifically only doing so for a particular length of time. In other words, this impedance circuit alteration is only carried out temporarily.

As is known, the tags transmit their information in a digital (and if need be encoded) form, by switching between various states, generally two states (for example between the state “0” and the state “1”). This takes place in that the impedance on the respective tag or transponder is switched, specifically by means of the chip disposed on the tag or transponder.

In accordance with the invention, it is provided that once the necessary communication between a reader and a relevant tag is ended, this tag is then switched into a different impedance circuit state. This state is selected in such a way that in this configuration, also referred to in the following as the standby impedance state, the tag or transponder causes a reduction in an undesired interaction with the antenna field of adjacent tags/transponders, in such a way that using the reader (i.e. the read and/or write device) and the associated antenna means, following tags or transponders can be addressed more effectively and the information saved on them can be read or other information can be written to them. This may for example take place in that the tag takes up less energy in the antenna field of the reader, i.e. draws less energy from the field, in the standby impedance state, or in that the current and/or potential distribution on the tag is changed in the standby impedance state in such a way as to reduce or optimise the reaction towards other tags or transponders.

After a following tag or transponder has correspondingly been read, it is likewise switched into what is known as the standby impedance mode and is thus switched into a state which is somewhat more favourable for the other, remaining tags or transponders or produces less reaction towards them, in particular into a state which is relatively “transparent” or “absent” from the point of view of the other tags.

The method according to the invention can still be applied if the tags or transponders, even in their initial or idle state, adopt or take on what is known as an initial impedance state, which is different from the two communication impedances states during switching from “0” to “1” and back. However, this need not necessarily be the case, and so the initial impedance state may also correspond to at least one of the two communication impedance states for transmitting “0” or “1”.

The associated tags or, in general, the associated transponders are thus constructed in such a way that after the completion of the required communication with the reader, the desired switching takes place, it being possible for the switching to be controlled by the transponder or by a protocol, i.e. by the transponder or RFID tag itself or for example by a corresponding control signal which is transmitted by the reader of the associated antenna.

However, the switching into a standby impedance state according to the invention need not necessarily take place directly after the termination of the at least two communication impedance states (switching between the states “0” and “1”), but may also take place at a somewhat deferred or delayed point in time. So, for example, if present, switching from the initial impedance state into the communication state, in which there is then switching back and forth between the two communication impedance states, may take place in such a way that there is then initially further switching into the initial impedance state or into one of the two communication impedance states, before switching into the standby impedance state is then finally carried out. It is also possible for there to be repeated alternation between for example the initial impedance state and the communication impedance state (for example during repeated exchange of information), or even for yet other intermediate impedance states of any desired duration and/or frequency to be assumed, until switching into the standby impedance state finally takes place.

The invention will be explained in greater detail in the following by way of example with reference to the drawings, in which, in detail:

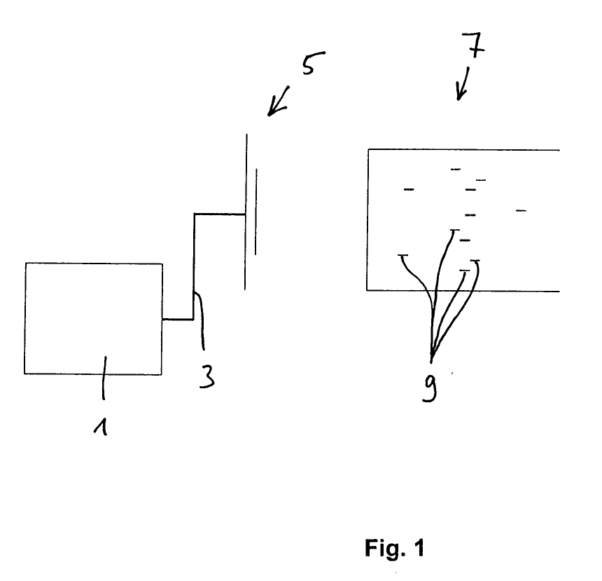

FIG. 1 is a schematic drawing of an RFID system for transmitting data from a large number of data carriers, preferably in the form of RFID tags, to a reader, using an antenna arrangement;

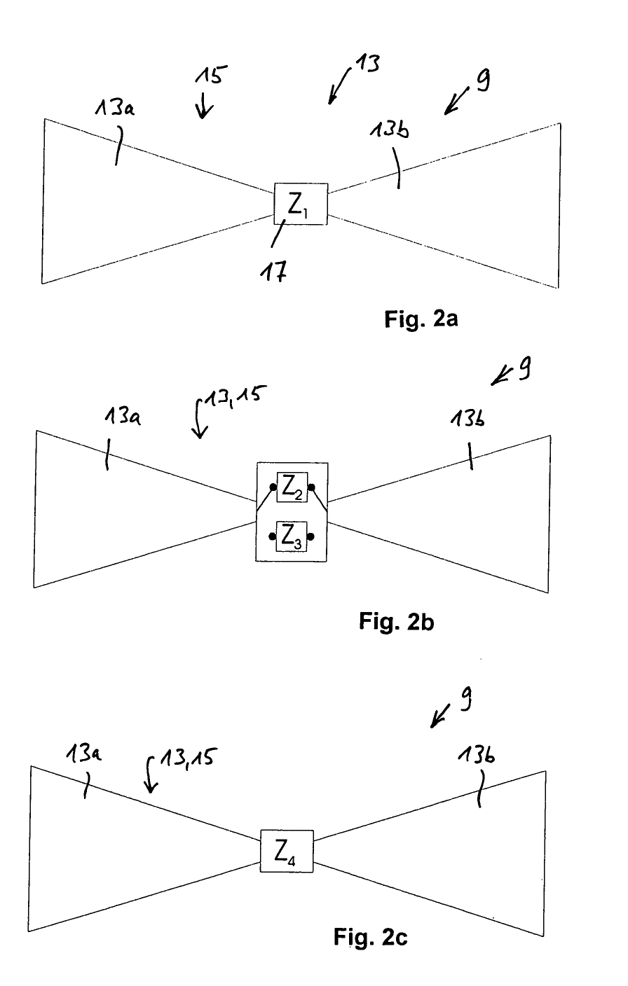

FIGS. 2a to 2c are schematic plan views of a tag/transponder with a dipole structure on the tag/transponder and with a chip with associated high-frequency impedance, showing three different impedance circuit states;

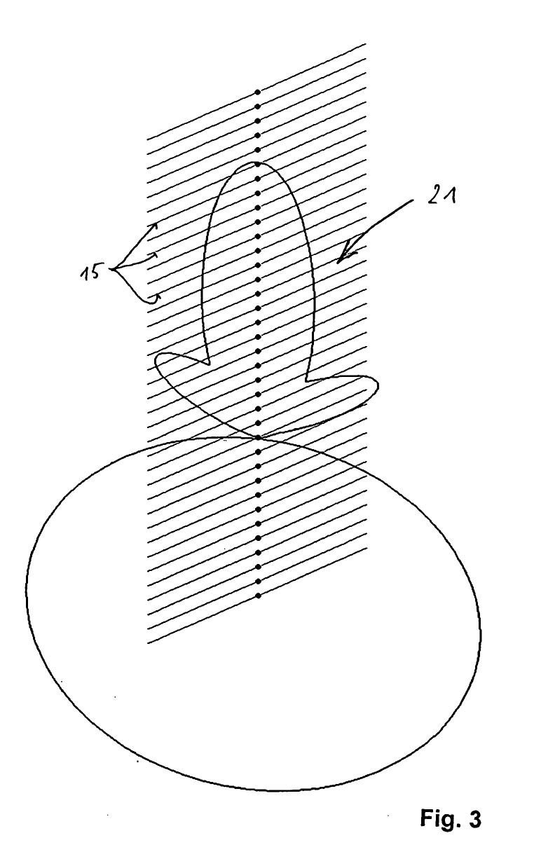

FIG. 3 is a schematic drawing of an RFID transponder arrangement with a large number of tags or transponders, showing a standardised antenna pattern when using conventional tags or transponders; and

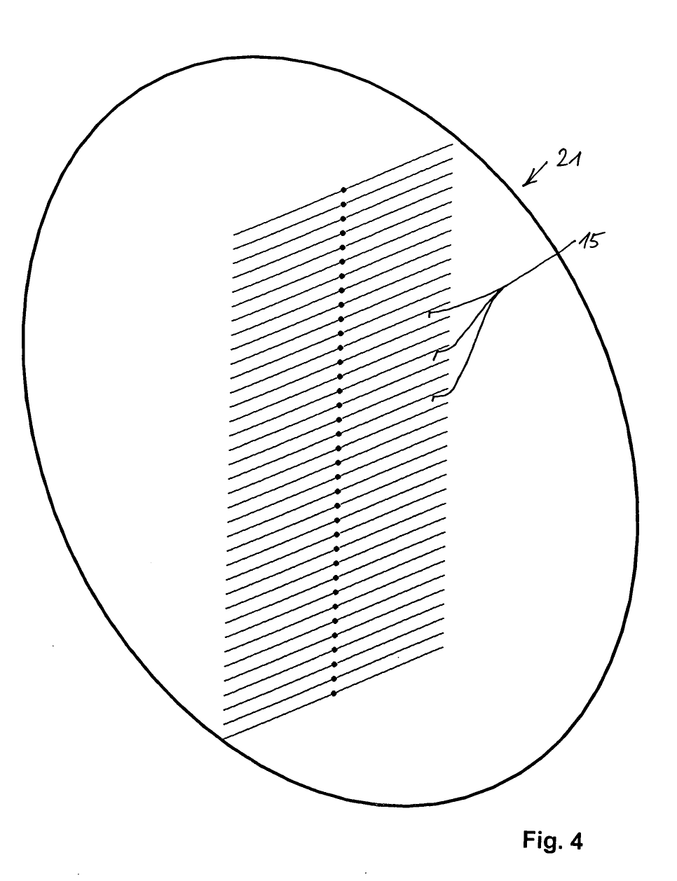

FIG. 4 is a view corresponding to FIG. 3 showing a standardised antenna pattern when using the method according to the invention or the tags or transponders according to the invention.

FIG. 1 is a schematic drawing of a transmission and/or receiving unit 1, i.e. what is known as a reader 1, which is connected via a line or cable 3 to an antenna or antenna arrangement 5.

The antenna arrangement in this case preferably consists of one or more joint transmission and/or receiving antennae. A product line-up, for example, or in general a number of objects or goods 7 such as items of clothing (T-shirts or the like) are to be provided at a distance from said antenna and are each provided with a tag or transponder 9 for sensing (detection, identification). This may be a tag 9 or in general a transponder 9, which is sometimes also referred to as a data or information carrier 9. The tags or transponders 9 in this case may be of identical or different constructions. The goods such as T-shirts, mentioned above purely by way of example, may for example be lying on top of one another in such a way that some of the individual tags 9 end up extremely close to one another.

These tags/transponders 9 may be provided with their own energy supply (active tags/transponders). They are basically constructed in such a way that they are provided with a tag antenna (not shown in greater detail in FIG. 1) for receiving signals from a reader with an integrated circuit arrangement on the substrate or carrier material, in which arrangement corresponding information is stored and may be read or written by a reader in a known manner.

When passive tags/transponders 9 are used, i.e. tags/transponders which have no energy supply of their own, they obtain their energy from the transmitted signal of the read/write device (reader) in such a way that they then read out the information stored on them and transmit it to the reader.

When “tags” are mentioned in the following, these are in general transponders, i.e. active or passive information carriers with or without their own energy supply, on which information carriers a chip and a corresponding transponder antenna are provided.

When the described technique is used in the RFID range, which may vary depending on the country, it is a technique in which transmitted and received signals are generally transmitted at the same frequency or in the same frequency band, for example in the range of 860 MHz to 960 MHz. However, the invention may also be implemented in completely different ranges, for example in the UHF range at 434 MHz or for example in the HF range at for example 13.56 MHz, or in the microwave range at 2.45 GHz. However, the invention can in principle also be used and implemented in other frequency ranges.

FIGS. 2a to 2c are schematic plan views of examples of a tag or transponder 9, but ultimately only show a dipolar antenna structure 13 with associated dipole halves 13a and 13b together with a microchip 17 which will be described further below. In other words, the border or what is known as the substrate of the information carrier 9, i.e. in particular of the tag/transponder 9, is not shown for reasons of clarity.

In the drawings, the antenna is shown as a dipole antenna with two dipole halves 13a and 13b. However, other types of antenna may also be used, and need not necessarily consist of dipole emitters (for example in the form of a slot antenna or the like). The tag further comprises a chip or microchip 17.

The construction is preferably of such a type that a corresponding tag or transponder has an initial state Z1 with a particular high-frequency impedance Z1 for the chip (FIG. 2a).

If an information carrier 9 of this type, for example in the form of a tag or a transponder 9, now receives a signal (for example what is known as an interrogation or read signal or else for example what is known as a write signal) from a reader 1, and this signal requires a response, then the microchip 17 switches into an altered impedance state which it requires for communication with the reader 1. In other words, the microchip 17 switches between two impedance states Z2 and Z3, i.e. back and forth, in such a way as to transmit the signal “0” or the signal “1” in accordance with the impedance state Z2 or Z3 respectively, i.e. to switch between these two signals. This allows the digital communication between the reader and the tag/transponder 9 to be maintained.

Once this communication has been concluded, i.e. the corresponding information has been read from the tag/transponder 9 and this information has been received and/or evaluated by the reader 1, according to the invention the microchip 17 should then switch into a further impedance state Z4, the third impedance state in the embodiment shown (FIG. 2c). This third impedance state Z4 is selected in such a way as to reduce the undesired interaction between the tag or transponder for which communication with the reader has already been concluded and the antenna field of adjacent tags or transponders. This may for example take place in that in this state, the tag/transponder 9 only takes up considerably less energy from the electromagnetic field emitted by the reader via the associated reader antenna 5 than another tag/transponder 9 which is still in the initial state Z1 or in the communication state with the selective impedance state Z2 or Z3.

This switching mechanism distinguishes the tag/transponder which has already been read previously as one which, in effect, produces relatively little reaction (i.e. is rather “transparent” or rather “absent”) towards the adjacent tags, with the result that now, adjacent following tags/transponders can communicate considerably better with the reader, since the interference (exertion of influence on the energy uptake), which is detrimental to communication, of some of the adjacent tags is reduced. The invention thus ensures that further, predominantly adjacent tags/transponders are effectively less shielded or adversely affected by the switching of the tags/transponders 9 which are read in each case and the switching of this tag/transponder into the aforementioned standby impedance state, communication with an adjacent tag/transponder 9 and the reader thus being improved.

However, the initial impedance Z1 need not necessarily be different from the communication impedances Z2 and Z3. In other words, the initial impedance Z1 may also correspond to the impedance Z2 or Z3. The advantages are still provided in this case in that the respective microchip switches into an impedance state Z4 after the exchange of information.

It is further noted that the aforementioned high-frequency impedances may have both linear and non-linear characteristics, in particular in relation to the power. It is further noted that the sequence proceeding from the initial impedance Z1 via the communication impedances Z2 and Z3 need not necessarily switch directly into the next impedance state Z4 after the exchange of information between tag/transponder 9 and reader 1. It is also possible, before switching into the standby impedance state Z4, to switch once again into the initial impedance state Z1 and only then to switch into the standby impedance state, or initially to switch once again from the initial impedance state via one or more communication impedance states Z2, Z3 into the standby state at a later point in time. These precursory switchings may if required take place several times before the standby impedance state is finally achieved,

The described switching into the standby impedance state Z4 may be carried out and ensured by constructing and/or programming the microchip 17 in a corresponding manner, the switching thus being initialised by the microchip 17 itself and/or at least being carried out under the control of the microchip 17. However, it is equally possible for switching into the standby impedance state Z4 to be triggered by a corresponding external signal, in particular a corresponding signal which is transmitted to the relevant information carrier 9 via the reader 1 and the associated antenna 5.

FIG. 3 shows schematically what a standardised antenna pattern 21 of a tag/transponder might look like if, for example, a large number of tags/transponders with corresponding tag/transponder antennae 15 are arranged so as to lie parallel close to one another. Thus, the resulting antenna pattern means that to some extent the transponders or tags are only able to receive a corresponding signal from the reader or to send information to the reader comparatively poorly.

If, for example, use was made of particular tags/transponders, which in accordance with the invention switched into the impedance state Z4 after the transmission of the desired information to the reader, this would result in an improved antenna pattern for other tags/transponders in the surroundings in accordance with FIG. 4. Whereas for example the representation of FIG. 3 shows the antenna pattern of an information carrier specifically at a point in time at which all the further (remaining) tags/transponders are for example in the initial impedance state or the communication impedance state (and in any case not in the standby impedance state Z4 provided by the invention), the standardised antenna pattern shown in FIG. 4 relates to an example according to the invention. By contrast with FIG. 3, FIG. 4 shows an embodiment of a standardised antenna pattern for a tag/transponder when for example all the remaining tags/transponders 9 are in the standby impedance state Z4 after the information has been read out. This shows that the transponders/tags, which are arranged in the same manner, can now receive a considerably stronger signal from particular directions and the communication between the reader and the transponder/tag is thus considerably improved. Comparing FIG. 3 and FIG. 4 also shows that the improved reception of signals and electromagnetic waves, i.e. in the energy field, naturally means not only that the reader can communicate better and thus more reliably with the individual tags/transponders, but also that the “intake field” is made larger for reading and sensing all of the tags/transponders, because in this configuration according to FIG. 4, the signals of the reader can still be received effectively even when the electric field strength decreases with increasing distance from the reader antenna.

The description provided makes it clear that switching into the standby impedance state Z4 takes place only for a particular duration, i.e. only temporarily, so as to contribute over this duration to a reduction in the undesired interaction with the antenna field of adjacent tags/transponders by altering the high-frequency impedance. Since the receivability and readability of the individual tags/transponders thus ultimately depends on the impedance of the other tags/transponders, the accessibility and the reading or writing of other tags can be improved by switching the tags/transponders in the measure described. If the received energy and/or if the energy still stored should fall below a minimum value or threshold, the arrangement may be such that the transponder/tag, i.e. in general the data or information carrier, returns to its initial impedance state in which it can again take more energy from the energy field emitted by the reader with the associated antenna.

It is also possible for the transponders/tags to adopt the standby impedance state Z4 from the outset only for a particular determined length of time. In this case, this period of time could for example have a fixed value (which is stored in the microchip) or alternatively be transmitted by the reader in each case during the communication between the reader and the transponder.

A further possibility is for the tags/transponders in the standby impedance state Z4 to be transferred into the initial impedance state or the communication impedance state by being directly addressed by the reader, as long as they have sufficient energy for this or can take sufficient energy from the available field.

1. Method for the contact-free transmission of data from and/or to a large number of data or information carriers (9), preferably in the form of RFID tags or transponders, with the following method steps:
transmitting one or more interrogation and/or write signals to one or more data or information carriers (9), in particular via an antenna arrangement (5) which is associated with or attached to a read and/or write device (1),
reading information from and/or writing information to an individual data or information carrier (9), in that a corresponding information signal is sent and/or received by the data or information carrier (9) via an antenna (15) located on the data or information carrier (9),
characterised by the following further features:
after the exchange of a piece of information between a read and/or write device (1) and a data or information carrier (9), said carrier is switched into a standby impedance state (Z4) to reduce an undesired interaction with the antenna field of adjacent data or information carriers (9), this state being distinguished from an initial impedance state (Z1) and communication impedance states (Z2, Z3) during the transmission of an information signal from the data or information carrier (9) or the reception of an information signal by the data or information carrier (9).

2. Method according to claim 1, characterised in that switching into the standby impedance state (Z4), in particular after the completion of the communication with the read and/or write device (1), is carried out by the data or information carrier (9) itself, i.e. in particular without a control signal provided by the read and/or write device (1).

3. Method according to either claim 1 or claim 2, characterised in that the standby impedance state (Z4) is selected in such a way that the data or information carrier (9) takes up less energy from a reader antenna (5) in this state than in the initial impedance state (Z1) and/or in the communication impedance state (Z2, Z3), in which the data or information carrier (9) transmits digitalised signals by switching between at least two impedance states (Z2, Z3).

4. Method according to any one of claims 1 to 3, characterised in that the standby impedance state (Z4) is selected in such a way that in this state, the data or information carrier (9) comprises a current and/or potential distribution on the antenna (15) which causes a lesser interaction with the antenna field of adjacent data or information carriers (9) than in the initial impedance state (Z1) and/or in the communication impedance state (Z2, Z3).

5. Method according to any one of claims 1 to 4, characterised in that the data or information carrier (9) comprises an initial impedance state (Z1) which is different from the communication impedance states (Z2, Z3) during the communication phase.

6. Method according to any one of claims 1 to 5, characterised in that the data or information carrier (9) comprises an initial impedance state (Z1) which corresponds to one of the two communication impedance states (Z2, Z3) which the data or information carrier (9) assumes during the communication phase.

7. Method according to any one of claims 1 to 6, characterised in that a data or information carrier (9) which has read or received a corresponding piece of information is then switched into a standby impedance state (Z4), in which it takes up less energy, in relation to signals transmitted by other data or information carriers (9), than a data or information carrier (9) which is in one of the two communication impedance states (Z2, Z3) or in the initial impedance state (Z1).

8. Method according to any one of claims 1 to 7, characterised in that a data or information carrier (9) which has read or received a corresponding piece of information is then switched into a standby impedance state (Z4), in which the state of the current and/or potential distribution on the antenna (15) causes a lesser interaction with the antenna field of adjacent data or information carriers (9) than in a data or information carrier (9) which is in one of the two communication impedance states (Z2, Z3) or in the initial impedance state (Z1).

9. Method according to any one of claims 1 to 7, characterised in that switching into the standby impedance state (Z4) is carried out only for a pre-specifiable or pre-specified duration.

10. Method according to claim 9, characterised in that a data or information carrier (9) which has read and/or received a corresponding piece of information and has then been switched into the standby impedance state (Z4) is switched back into its initial impedance state (Z1) when the energy supply and/or the energy state of the relevant data or information carrier (9) falls below a minimal value.

11. Method according to either claim 9 or claim 10, characterised in that a data or information carrier (9) which has read and/or received a corresponding piece of information and has then been switched into the standby impedance state (Z4) is switched back into its initial impedance state (Z1) when it receives a corresponding activation signal from the read and/or reception device (1).

12. Method according to any one of claims 9 to 11, characterised in that a data or information carrier (9) which has read and/or received a corresponding piece of information and has then been switched into the standby impedance state (Z4) is switched back into its initial impedance state (Z1) after a duration which is stored and/or pre-selectable and/or alterable in a microchip (17).

13. Method according to any one of claims 1 to 12, characterised in that after an information signal is read or received by the data or information carrier (9) before switching into the standby impedance state (Z4), one or more further switchings take place, initially into the initial impedance state (Z1) and optionally into at least one of the two communication impedance states (Z2, Z3).

14. Method according to any one of claims 1 to 13, characterised in that switching into the standby impedance state (Z4) is carried out by a microchip provided on the data or information carrier (9).

15. Method according to any one of claims 1 to 14, characterised in that switching into the standby impedance state (Z4) takes place after a corresponding piece of information is read by the data or information carrier (9), under the control of the read and/or write device (1) and/or triggered by the read and/or write device (1).

16. Device for the contact-free transmission of data from a large number of data or information carriers (9), preferably in the form of RFID tags or transponders, with the following method features:
a read and/or write device (1) is provided which comprises one or more antennae (5) or to which one or more antennae (5) can be attached, it being possible to transmit interrogation and/or write signals to one or more data or information carriers (9) via said antennae,
a plurality of data and/or information carriers (9) are provided, on which there is contained and/or stored information which can be read by the data or information carrier (9), in particular after an interrogation signal is received by the transmission of an information signal, or to which information can be saved, in particular after a write signal is received,
characterised by the following further features:
the data or information carrier (9) comprises a microchip (17) which can assume different impedance states (Z1; Z2; Z3; Z4), and which is switched, after an information signal is transmitted and/or received, from a communication impedance state (Z2, Z3) into a standby impedance state (Z4) which is distinguished from an initial impedance state (Z1) and/or from a communication impedance state (Z2, Z3) during the transmission of an information signal from the data or information carrier (9).

17. Device according to claim 16, characterised in that the data or information carrier (9) is constructed in such a way that switching into the standby impedance state (Z4), in particular after the completion of the communication with the read and/or write device (1), is carried out by the data or information carrier (9) itself, i.e. in particular without a control signal provided by the read and/or write device (1).

18. Device according to either claim 16 or claim 17, characterised in that in the standby impedance state (Z4), the microchip (17) has an impedance such that the data or information carrier (9) takes up less energy from an electric, magnetic or electromagnetic field produced by an antenna, in particular a reader antenna (5), than in the initial impedance state (Z1) and/or in the communication impedance state (Z2, Z3), in which the data or information carrier (9) transmits digitalised signals by switching between at least two impedance states (Z2, Z3).

19. Device according to any one of claims 16 to 18, characterised in that in the standby impedance state (Z4), the microchip (17) has an impedance such that the data or information carrier (9) comprises a current and/or potential distribution on the antenna (15) which causes a lesser interaction with the antenna field of adjacent data or information carriers (9) than in the initial impedance state (Z1) and/or in the communication impedance state (Z2, Z3).

20. Device according to any one of claims 16 to 19, characterised in that microchip (17) comprises an initial impedance state (Z1) which is different from the communication impedance states (Z2, Z3) during the communication phase.

21. Device according to any one of claims 16 to 18, characterised in that the data or information carrier (9) comprises an initial impedance state (Z1) which corresponds to one of the two communication impedance states (Z2, Z3) which the data or information carrier (9) assumes during the communication phase.

22. Device according to any one of claims 16 to 21, characterised in that a data or information carrier (9) which has read or received a corresponding piece of information can be or is switched into a standby impedance state (Z4), in which it takes up less energy, in relation to signals transmitted by other data or information carriers (9), than a data or information carrier (9) which is in one of the two communication impedance states (Z2, Z3) or in the initial impedance state (Z1).

23. Device according to any one of claims 16 to 22, characterised in that switching into the standby impedance state (Z4) can be or is carried out only for a pre-specifiable or pre-specified duration.

24. Device according to claim 23, characterised in that a data or information carrier (9) which has read and/or received a corresponding piece of information and has then been switched into the standby impedance state (Z4) can be or is switched back again into its initial impedance state when the energy supply and/or the energy state of the relevant data or information carrier (9) falls below a minimal value.

25. Device according to either claim 23 or claim 24, characterised in that a data or information carrier (9) which has read and/or received a corresponding piece of information and has then been switched into the standby impedance state (Z4) can be or is switched back again into its initial impedance state (Z1) when it receives a corresponding activation signal from the read and/or reception device (1).

26. Device according to any one of claims 23 to 25, characterised in that a data or information carrier (9) which has read and/or received a corresponding piece of information and has then been switched into the standby impedance state (Z4) can be or is switched back again into its initial impedance state (Z1) after a duration which is stored and/or pre-selected and/or alterable in a microchip (17).

27. Device according to any one of claims 16 to 26, characterised in that after an information signal is read or received by the data or information carrier (9) before switching into the standby impedance state (Z4), one or more further switchings take place, initially into the initial impedance state (Z1) and/or again into at least one of the two communication impedance states (Z2, Z3).

28. Device according to any one of claims 16 to 27, characterised in that switching into the standby impedance state (Z4) is carried out by a microchip provided on the data or information carrier (9).

29. Device according to any one of claims 16 to 28, characterised in that switching into the standby impedance state (Z4) takes place after a corresponding piece of information is read and/or written by the data or information carrier (9), under the control of the read and/or write device (1).
